(19) United States
(12) Patent Application Publication
(10) Pub. No.: US 2017/0026617 A1
(43) Pub. Date: Jan. 26, 2017

(54) METHOD AND APPARATUS FOR REAL-TIME VIDEO INTERACTION BY TRANSMITTING AND DISPLAYING USER INTERFACE CORREPSONDING TO USER INPUT

(71) Applicant: SYLapptech Corporation, Taipei (TW)

(72) Inventor: JIAN-HUA WANG, New Taipei (TW)

(21) Appl. No.: 14/804,345

(22) Filed: Jul. 21, 2015

(51) Int. Cl. H04N 7/15; H04N 7/14; G06F 3/0488

(52) U.S. Cl. CPC H04N 7/15; G06F 3/04883; H04N 7/147

(57) ABSTRACT

The present invention discloses a network for enabling real-time interaction comprising an enquirer node and a helper node, wherein the two nodes establish a connection between each other. Among the connection they further establish a video streaming layer for transmitting the video in form of video streaming data from the enquirer node to the helper node and an interaction layer for exchanging user input between the enquirer node and the helper node; wherein the enquirer node generates the second user interface with the first UI module according to the second user input received from the helper node via the interaction layer and displays the second user interface upon the video; and wherein the helper node generates the first user interface with the second UI module according to the first user input received from the enquirer node via the interaction layer and displays the first user interface upon the video.

The present disclosure generally relates to data structure of transmission and user interface enabling real-time video interaction. More specifically, the present disclosure is related to a method, an apparatus and a network having at least two apparatuses enabling real-time video interaction by transmitting user interface corresponding to user input and displaying over video stream.

### BACKGROUND

Generally, a mobile device may have a real-time communication with another mobile device via installed video phone applications such as Facetime and Skype, which allows users to speak and see each other with a preinstalled video capture unit on the mobile device. Information of the environment surrounding the mobile device may also be obtained by the video capture unit and sent to the recipient via the video phone applications of the mobile devices. Instead of sharing video of physical world, electronic whiteboard, screen Sharing of Skype or other online meeting apparatus, on the other hand, may enable users to share content (usually screen of content) of the devices and interact by sharing control of the shared screen. Broadcasting information through Social Network Service may be a way of interaction, which allows users to interact with each other by posting text message by one and respond to the text message by another.

However, while some software and devices may enable face to face communication, they may not allow image or video sharing at the same time. Electronic whiteboards are often limited to sharing and interact among the content of the computer instead of the environment where the device is in. Posting message on Social Network Service, on the other hand, may lack promptness. Hardly any kind of the current communication methods provide a solution to allow real-time collaboration based video related to the environment.

According to the above, what is needed is a method or an apparatus using such method for a first device to establish a connection comprising at least one layer for video sharing and at least one layer for interaction between one or more second devices. Therefore, the connection may realize real-time communication with one or more second electronic devices. The real-time communication may include sharing the image or video related to the environment surrounding the first electronic device and interacting with user interfaces directly displayed upon the video with the one or more second electronic devices at the same time.

### SUMMARY OF THE INVENTION

The present invention provides a method for enabling real-time interaction between a first device and a second device. The method may include the steps of sending by the first device a request for connection, a context related to the environment, and an IP address of the first device to a management server; matching by the management server the first device to the second device; sending by the management server the request for connection, the context and the IP address of the first device to the second device and the IP address of the second device to the first device; establishing by the first and the second devices a connection between each other, and wherein the connection comprises a video streaming layer for transmitting video streaming data to the second device and an interaction layer for exchanging user input data between the first and the second devices; obtaining by the first device a video from the environment; sending by the first device the video to the second device via the video streaming layer; displaying the video on both the first and the second devices; receiving by one of the devices one or more user inputs and transmitting to another via the interaction layer; performing user interface operation corresponding to the user inputs to the video by both of the devices; and displaying the result of the operation upon the video on both devices. As a result, the first device may provide the video of the environment it is in to the second device and realize real-time interaction by user interfaces displayed upon the video according to user inputs detected by both devices.

The invention also provides an apparatus for enabling real-time interaction. The apparatus may be a first electronic device and may comprise a memory, along with one or more processors, a communication module, a video capture unit, an input module, and a display, having one or more programs stored in which enables real-time interaction with a second electronic device. The one or more programs includes instructions for sending a request for connection, a context related to the environment received by the input module, and an IP address of the first electronic device to a second electronic device via a management server, and wherein the management server matches the first electronic device to the second electronic device according to data received from the first electronic device; establishing a connection between the first electronic device and the second electronic device by the communication module, and the connection comprises a video streaming layer for transmitting video streaming data to the second electronic device and an interaction layer for exchanging user input data between the first and the second electronic devices; obtaining a video from the environment by the video capture unit and displaying the video on the display; sending by the communication module the video to the second electronic device via the video streaming layer for being displayed by the second electronic device; receiving by the communication module one or more user inputs from the second electronic device via the interaction layer; executing a user interface operation to the video according to the one or more user inputs and displaying the result of the user interface operation upon the video on the display. As a result, the first electronic device may provide the video of the environment it is in to the second electronic device and realize real-time interaction combining additional user inputs detected by both electronic devices.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

Implementations of the present technology will now be described, by way of example only, with reference to the attached figures.

FIG. 1 is schematic illustration of the network architecture according to embodiments of the present invention;

FIG. 2 is a block diagram of an enquirer device according to one embodiment of the present invention;

FIG. 3 is a block diagram of another enquirer device according to one embodiment of the present invention;

FIG. 4 is a block diagram of a helper device according to one embodiment of the present invention;

FIG. 5 is a flowchart illustrating the method for realizing a real-time interaction between two electronic devices within a network according to one embodiment of the present invention;

FIG. 6 is a flowchart illustrating the method for realizing a real-time interaction between two electronic devices within a network according to another embodiment of the present invention;

FIG. 7 is a flowchart illustrating the method for realizing a real-time interaction by a enquirer device according to one embodiment of the present invention;

FIG. 8 is a flowchart illustrating the method for realizing a real-time interaction by an enquirer device according to another embodiment of the present invention;

FIG. 9 is a flowchart illustrating the method for realizing a real-time interaction by a helper device according to one embodiment of the present invention;

FIG. 10 is a flowchart illustrating the method for realizing a real-time interaction by a management server according to one embodiment of the present invention;

FIG. 11 is a schematic illustration of a series of user interface operations performed for real-time interaction between the enquirer node and the helper node according to one embodiment of the present invention;

FIG. 12 is a schematic illustration of a series of user interface operations performed for real-time interaction between the enquirer node and the helper node according to one embodiment of the present invention;

FIG. 13 is a schematic illustration of a series of user interface operations performed for real-time interaction between the enquirer node and the helper node according to one embodiment of the present invention;

FIG. 14 is a schematic illustration of a series of user interface operations performed for real-time interaction between the enquirer node and the helper node according to one embodiment of the present invention;

FIG. 15 is a schematic illustration of a series of user interface operations performed for navigation instruction from the helper node to the computing device according to one embodiment of the present invention.

In accordance with common practice, the various described features are not drawn to scale and are drawn to emphasize features relevant to the present disclosure. Like reference characters denote like elements throughout the figures and text.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

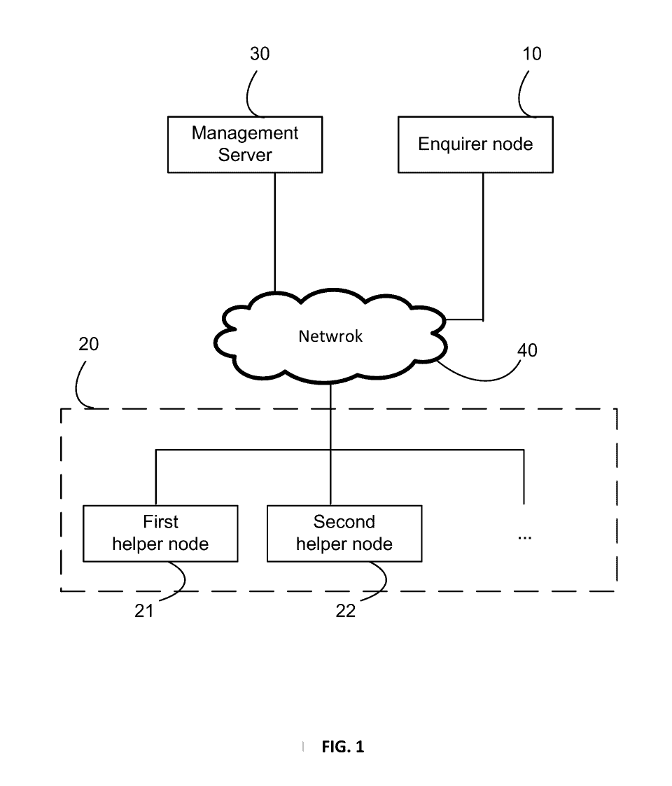

The description will be made as to the embodiments of the present invention in conjunction with the accompanying drawings in FIGS. 1-14. Reference will be made to the drawing figures to describe the present invention in detail, wherein depicted elements are not necessarily shown to scale and wherein like or similar elements are designated by same or similar reference numeral through the several views and same or similar terminology.

In accordance with the purposes of this invention, as embodied and broadly described herein, FIG. 1 illustrates the network architecture to one embodiment of the present invention. Referring to FIG. 1, an enquirer node 10 may connect with a network 40 for enquiring a request to one or more helper nodes 20 in the network 40. In one of the embodiment of the present invention, the enquirer node 10 may send an IP address, a context related to environment surround the enquirer node 10 and a connection request of the enquirer node 10 to the one or more helper nodes 20, and the one or more helper nodes 20 may send the IP address of the one or more helper nodes 20 to the enquire node 10 for the enquirer node 10 and the one or more helper nodes 20 to establish a connection between each other. In another embodiment of the present invention, a management server 30 may connect with the network 40. The enquire node 10 may send its IP address, the context and the connection request to the management server 30 for the management server 30 sending to at least one helper node. The management server 30 may match at least one of the one or more helper nodes 20 such as a first helper node 21 and send the IP address, the context and the connection request to the first helper node 21 according to data received from the enquire node 10. In some implementations, the management server 30 may match the enquirer mode 10 to one or more of the helper nodes 20 according to an identification received from the enquirer node 10. In some implementations, the management server 30 may receive geographic data of the enquirer node 10 and match the enquirer node 10 to one or more of the helper nodes 20 based on the geographic data. For example, the management server 30 may match the enquirer node 10 to one or more of the helper nodes 20 which are geographically near to the enquirer node 10. For another example, the management server 30 may match the enquirer node 10 to one or more of the helper nodes 20 whose users have visited region geographically near to the enquirer node 10. After matching the enquire node 10 to the one or more of the helper nodes 20, the management server 30 may send an IP address, a context and a connection request of the enquire node 10 to the one or more helper nodes 20 and the IP address of the one or more helper nodes 20 to the enquire node 10. As a result, the enquire node 10 and the one or more helper nodes 20 may have the IP address of each other. The enquire node 10 and the one or more helper nodes 20 may establish a connection between each other based on the IP addresses. Some approach known to person having ordinary skill in the art such as peer-to-peer connection may be adopted for establishing the connection.

The connection may comprise at least a first layer for video streaming data transmission (denoted as “video streaming layer”) and a second layer for user for control or user interface data transmission (denoted as “interaction layer”). After the connection set up, the enquire node 10 may communication with the one or more helper nodes 20 via the connection. The enquirer node 10 may obtain a video from the environment surrounding to itself and transmit to the one or more helper nodes 20 via the video streaming layer of the connection. In some implementations, the one or more enquirer nodes 10 and the one or more helper nodes 20 may both display the video. That is, they may share the same screen of the video. The one or more helper nodes 20 and the enquire node 10 may further receive user input and transmit corresponding user interface data or corresponding command to each other via the interaction layer of the connection. The user interface data or command transmitted via the interaction layer may be displayed upon the video transmitted via the video streaming layer on both the enquirer node 10 and the one or more helper nodes 20. In some implementations, as a result, the one or more helper nodes 20 and the one or more enquirer nodes 10 may share the same screen of the video and the user interface data. Therefore, users of the enquirer node 10 and the one or more helper nodes 20 may communicate based on the video and having visual aids for interaction. Therefore, real-time communication about the environment surrounding to the enquirer node 10 with real-time visual interaction directly on the video may be enabled between the enquirer node 10 and the one or more helper nodes 20. As a result, while a user of the enquirer node 10 having questions related to surrounding environment, the embodiment of the present invention may enable the user to consult from users of the one or more helper nodes 20 via real-time communication with visually aided interaction.

The enquirer node 10 of the present invention may be a smart phone, a tablet computer, a laptop computer, a digital camera, a video recorder or a wearable computing device such as a wrist-wearable device and a head-mount device. In addition, the enquirer node 10 of the present invention may also be any device capable of connecting to the network and having a video capturing unit for obtaining video from the environment surrounding the enquirer node 10 and a video display unit for displaying the video and the user interface. In some implementations, the enquirer node 10 may be a computing device attachable to a moving object such as a person, a pet, or a vehicle. For example, the enquirer node may be an on-board unit (OBU) capable of placing in an automobile or a console incorporated in an automobile. In some implementations, the enquirer node 10 may further be a moving object having network connectivity and video capturing capability such as an unmanned vehicle having a camera.

Similarly, the one or more helper node 20 of the present invention may be a smart phone, a tablet computer, a laptop computer, an electronic book reader, a digital photo frame, a set-top box, a smart television, an electronic white board, a router, a wireless access point or a remote radio head (RRH). In addition, the one or more helper node 20 of the present invention may also be any device capable of connecting to the network, capable of displaying video data received from the enquirer node 10 and an input unit for receiving user input as user's reaction to the video data. In some implementations, the one or more helper node 20 may be a video display device having means for receiving user input corresponding to displayed video such as a computing device having a touch screen or a smart television having camera and image recognition function to receive and identify gestures from its user. In some implementations, the one or more helper node 20 may further be a network connecting device capable of connecting to display device and input device simultaneously such as a set-top box connecting to a display and a camera device having image recognition function to receive and identify gestures from its user.

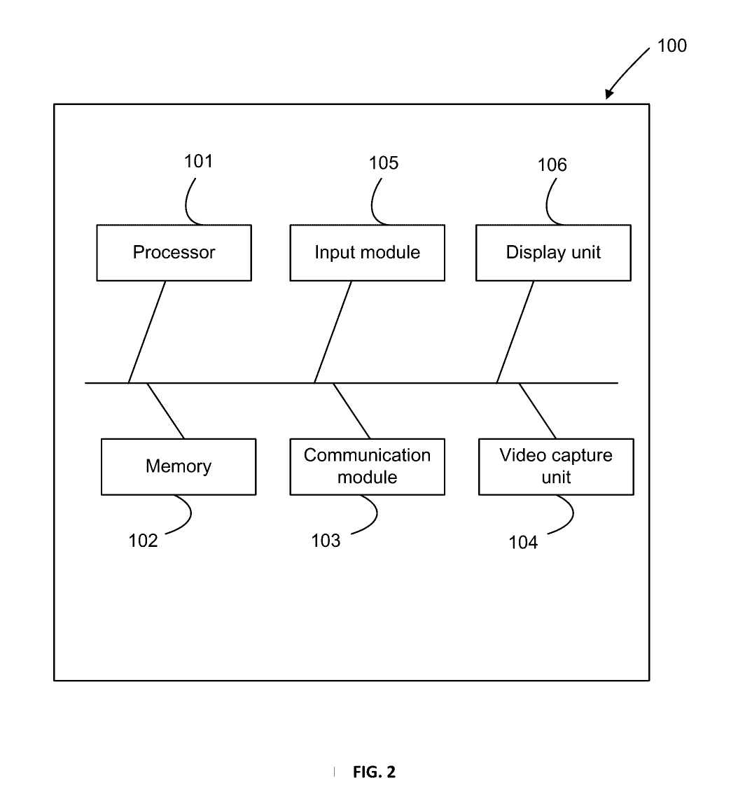

Referring to FIG. 2, the enquirer node 10 may be a first electronic device 100 including a processor 101, a memory 102, a communication module 103 connected to the memory 102 and controlled by the processor 101, a video capture unit 104 connected to the memory 102 and controlled by the one or more processors 101, an input module 105, and a display 106. The connecting procedure between the first electronic device 100 and the one or more helper nodes 20 depicted in FIG. 1 may also be stored as the one or more programs in the memory 102. The processor 101 may perform the programs to take an initiative to establish connection for communicating with the helper node 20 by controlling the communication module 103 to send a request for connection. The communication module 103 then may establish the connection comprising a video streaming layer for transmitting video streaming data, obtained by the video capture unit 104 from the environment where the first electronic device 100 is in, to the helper node 20 and an interaction layer for exchanging user input data, collected by the input module 105, between the first electronic device 100 and the helper node 20. The video streaming data obtained by the video capture unit 104 may also be displayed on the display unit 106. The processor 101 may further execute a first user interface operation to the video streaming data according to the user inputs and display the result of the first user interface operation upon the video streaming data on the display unit 106. In some implementations, the communication module 103 may further receive user interface data via the interaction layer from the one or more helper nodes 20. The processor 101 may further perform a second user interface operation according to the user interface data received from the one or more helper nodes 20 and display the result of the second user interface operation upon the video streaming data 411 on the display unit 106.

In one embodiment of the present invention, the input module 105 may receive a context related to the environment and the communication module 103 may send the context to the one or more helper node 20 along with an IP address of the first electronic device 100. In some implementations, the first electronic device 100 may send the context, the IP address and the connection request to the management server 30. The management server 30 may then match the first electronic device 100 to one or more of the helper node 20 and send the context, the IP address and the connection request to the one or more helper nodes 20.

In one embodiment of the present invention, the first electronic devices 100 may also comprise a geographic sensor 107 for obtaining geographic data from the environment. The communication module 103 may further send the geographic data to the helper node 20 via the interaction layer. In some implementations, the communication module 103 may send the geographic data to the management server 30. The management server 30 may match the first electronic device 100 to the one or more helper nodes 20 based on the geographic data. For example, the management server 30 may match the first electronic device 100 to the nearest of the one or more helper nodes 20. For another example, the management server 30 may match the first electronic device 100 to the one or more helper nodes 20 whose user has visited a location corresponding to the geographic data. In some other implementations, the first electronic device 100 may obtain map data related to the geographic data by the communication module 103. The processor 101 may generate a map corresponding to the map data. The display unit 106 may display the map, the video simultaneously. In some scenario, the processor 101 may construct a navigation user interface including map, position of the first electronic device 100 and the video collected by the video capture unit 104. The communication module 103 may receive direction guides from the one or more helper nodes 20. The processor may generate direction icons corresponding to the direction guides, and the display unit 106 may display the navigation user interface and the direction icons accordingly.

In one embodiment of the present invention, the processor 101 may also recognize an object in the video obtained by the video capture unit 104. The processor 101 may obtain one or more characteristics of the object such as the name of the object via the communication module 103. The communication module 103 sends the one or more characteristics to the helper node 20 via the interaction layer. In some implementation, the processor may generate recognition data such image features of the object while recognizing the object. The communication module 103 may send recognition data to the management server 30. The management server 30 may retrieve the characteristics of the object with the recognition data. In some scenarios, the object may be a product. The processor 101 may recognize the product by matching image features and generate an ID representing the product. The communication module 103 may send the ID to the management server 300 (or other servers including a product database). The management server 300 may retrieve product information such as the model number, the name and the price of the product by the ID and send to the first electronic device 100. The display unit 106 may display the product information along with the video. The communication module may further transmit the product information or the ID to the one or more helper nodes 20 via the interaction layer for the one or more helper nodes 20 displaying the product information along with the video, too.

In one embodiment of the current invention, the user input data received by the input module 105 from the one or more helper nodes 20 via the interaction layer may be a touch or gesture, and the one or more processors 101 may apply one or more heuristics to the user input data to determine a first user interface operation. The one or more processors 101 then executes the first user interface operation to the video streaming data accordingly and display the result of the first user interface operation upon the video streaming data captured by the video capture unit 104 on the display unit 106. In another embodiment of the current invention, the input module 105 may comprise one or more touch sensors for detecting finger contacts and generating touch data. The one or more processors 101 may also apply one or more heuristics to the touch data to determine a second user interface operation and perform the second user interface operation to the video streaming data accordingly and display the result of the first user interface operation upon the video streaming data captured by the video capture unit 104 on the display unit 106. The communication module 103, on the other hand, sends the touch data detected by the touch sensor to the one or more helper nodes 20.

In one embodiment of the current invention, the input module 105 may comprise one or more light sensors for detecting user behavior and generating gesture data. The one or more processors 101 may also apply one or more heuristics to the gesture data to determine a second user interface operation and perform the second user interface operation to the video streaming data accordingly and display the result of the first user interface operation upon the video streaming data captured by the video capture unit 104 on the display unit 106. The communication module 103, on the other hand, sends the gesture data detected by the light sensor to the one or more helper nodes 20.

In one embodiment of the current invention, the one or more the one or more processors 101 take a screen shot including a frame image of the video streaming data the result of the first user interface operation, and the communication module 103 sends the screen shot to the one or more helper nodes 20 via the interaction layer. Hence the first electronic device 100 and the one or more helper nodes 20 can interact and collaborate using through the screen shot.

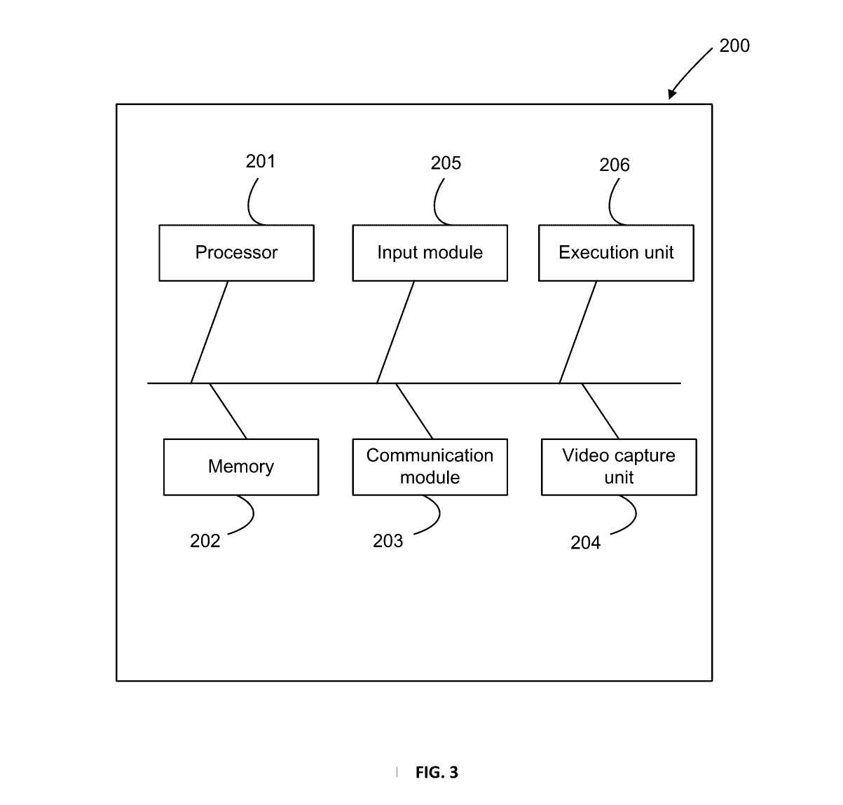

Referring to FIG. 3, the enquirer node 10 may also be a computing device 200 controlling a vehicle body of an unmanned vehicle. The computing device 200 includes one or more processors 201, a memory 202, a communication module 203 controlled by the one or more processors 201, a video capture unit 204 connected to the memory 202 and controlled by the one or more processors 201, an input module 205, an execution unit 206, and one or more programs stored in the memory 202 and configured to be executed by the one or more processors 201. In one embodiment of the present invention, the connecting procedure between the first electronic device 200 and the one or more helper nodes 20 depicted in FIG. 1 may also be stored as a the one or more programs in the memory 202. The one or more processors 201 may perform the programs to take an initiative to establish connection for communicating with the one or more helper nodes 20 by controlling the communication module 203 to send a request for connection. The communication module 203 then establishes the connection comprising the video streaming layer for transmitting video streaming data, obtained by the video capture unit 204 from the environment where the vehicle is in, to the one or more helper nodes 20 and the interaction layer for exchanging user input data, collected by the input module 205, between the computing device 200 and the one or more helper nodes 20. The one or more processors 201 may process the user input data received from the one or more helper nodes 20 by the communication module 203, apply one or more heuristics to the one or more user input data to determine one or more commands defining interaction between the vehicle and the environment, and execute the one or more commands to control the vehicle body to perform the interactions with the environment with the execution unit 206.

In one embodiment of the present invention, the one or more user input data may be a touch data defining at least a location corresponding to the environment in one or more frame images of the video streaming data. The one or more processor 201 then execute one or more commands with the execution unit 206 to control the vehicle body to move to the location in the environment.

In another embodiment of the present invention, the one or more programs 1021 further comprise instructions for sending a request for connection, a pre-set context, and an IP address of the vehicle to the one or more helper nodes 20 via the management server 30. After receiving those data from the computing device 200 of the vehicle, the management server 30 matches the vehicle to the one or more helper nodes 20 accordingly.

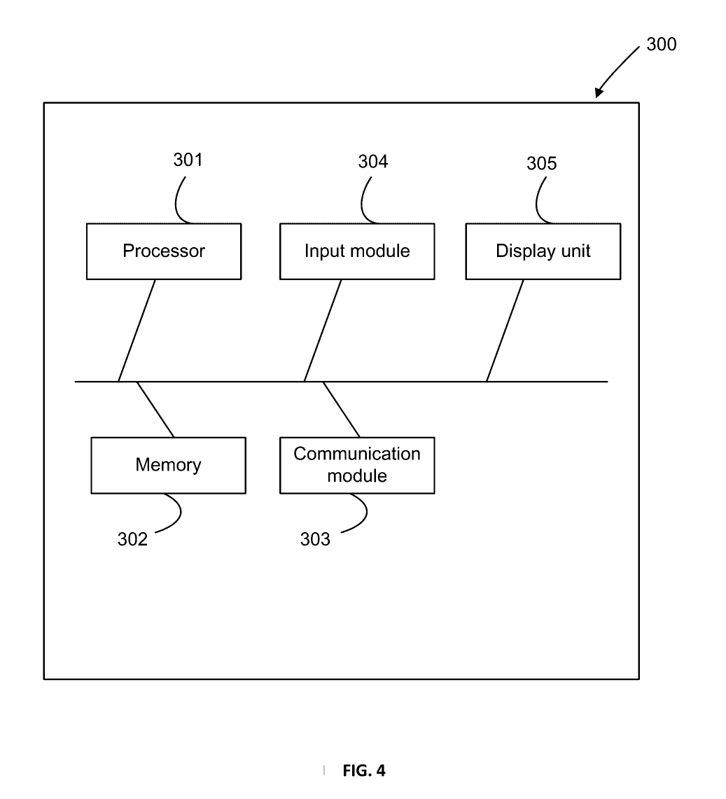

Referring to FIG. 4, the one or more helper nodes 20 may be a second electronic device 300 including one or more processors 301, a memory 302, a communication module 303 controlled by the one or more processors 301, an input module 304, a display 305, and one or more programs stored in the memory 302 and configured to be executed by the one or more processors 301. In one embodiment of the present invention, the communication module 303 may receive a context related to the environment surrounding the enquirer node 10 along with an IP address of the enquirer node 10 and the connection request from the management server 30. Hence the connection between the second electronic device 300 and the enquirer node 10 may then be established by the communication module 303. The connecting procedure between the second electronic device 300 and the enquirer node 10 depicted in FIG. 1 may also be stored as the one or more programs in the memory 302. The one or more processors 301 may perform the programs to establish connection for communicating with enquirer node 10 by controlling the communication module 303 to receive a request for connection. The communication module 303 then establishes the connection comprising a video streaming layer for receiving the video streaming data from the enquirer node 10 and an interaction layer for exchanging user input data, collected by the input module 304, between the second electronic device 300 and enquirer node 10. The video capture unit 304 may also display the video streaming data via the display unit 305. The one or more processors 301 also executes an user interface operation to the video streaming data according to the user inputs and display the result of the user interface operation upon the video streaming data on the display unit 306.

The processor 101, 201 or 301 of the present invention may be a processor or a controller for executing the program instruction in the memory 102, 202 or 302 which may be SRAM, DRAM, EPROM, EEPROM, flash memory or other types of computer memory. The processor 101 may further include an embedded system or an application specific integrated circuit (ASIC) having embedded program instructions.

The communication module 103, 203 or 303 of the present invention may adopt customized communication protocols or following (de facto) communication standards such as Ethernet, IEEE 802.11 series, IEEE 802.15 series, Wireless USB or telecommunication standards such as GPRS, CDMA2000, TD-SCDMA, LTE, LET-Advance or WiMAX standards. The communication module 103, 203 or 303 may also adopt customized multimedia encoding/decoding algorithms or following (de facto) multimedia compression standards such as MPEG series, H.264, H.265 or HEVC.

The video capture unit of 104 or 204 may comprise a camera, an image sensor and a buffer memory for obtaining images from the environment and generating image frames of video. In some implementations, the video capture unit may also be a video interface for connecting to video capturing devices.

The input module 105, 205 or 304 may be a keyboard, a mouse, a control panel or other input means to receive user's input. In some implementations, the input module 105, 205 or 304 may have sensor and recognition to detect user input. For example, the input module 105, 205 or 304 may comprise one or more touch sensors for detecting finger contacts and generating touch data which defines at least a point in one or more frame images of the video corresponding to at least a location in the environment where the enquirer node 10 is in. In another embodiment of the present invention, the input module 105, 205 or 304 may comprise one or more light sensors for identifying at least a position pointed by a light source in one or more frame images of the video corresponding to at least a location in the environment where the enquirer node 10 is in. In another implementations, the input module 105, 205 or 304 may comprise image sensor or touch sensor to collect image data or touch data and identify gestures in the image data or touch data. The input module 105, 205 or 304 may generate corresponding gesture data to be transmitted in the interaction layer instead of the touch data or the image data collected from the input module 105, 205 or 304.

The display unit 106 or 305 of the present invention may be any device capable of displaying video. The display unit 106 or 305 of the present invention may also be an interface for connected to display devices which may include an external monitor for computing device, a television or a projecting device.

The execution unit 206 of the present invention may be any device having various level of capability to physically interact with the environment, such as moving to specific location in the environment or capturing/placing an object in the environment. For example, the execution unit 206 may be a vehicle body or one or more robotic arms.

In one embodiment of the present invention, the connection between the enquirer node 10 and the one or more helper nodes 20 further comprises a voice communication layer for exchanging voice data between the enquire node and the helper node.

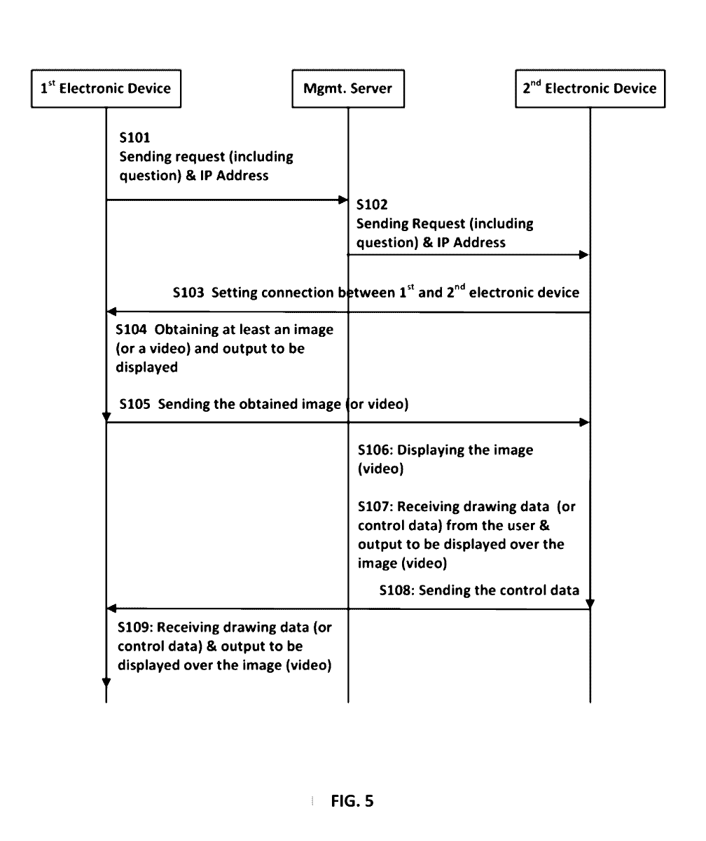

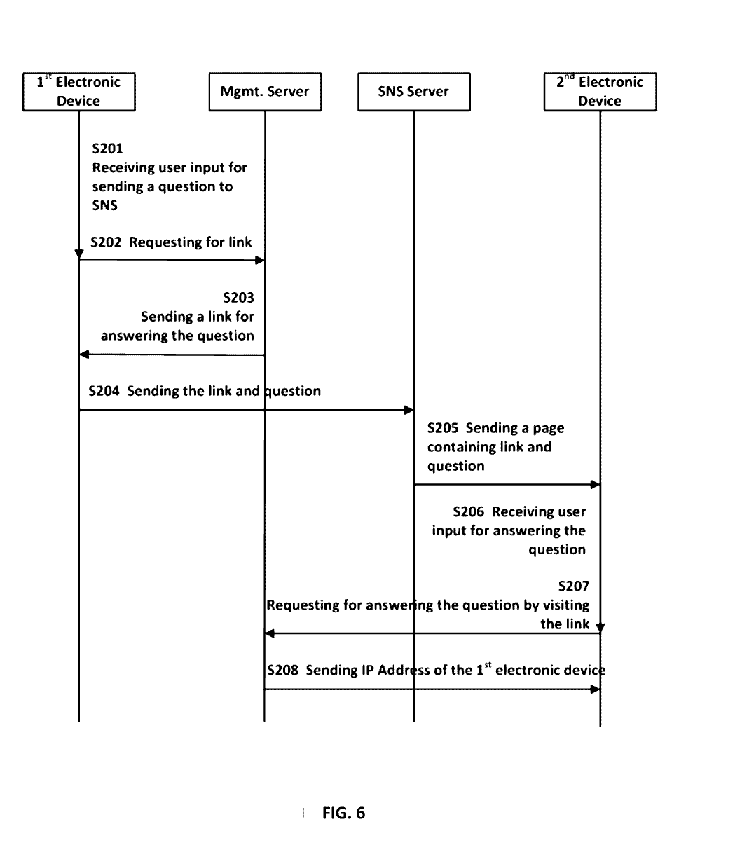

FIGS. 5 to 6 illustrate the method for real-time interaction between an enquirer node 10 and one or more helper nodes 20 in a network 40 according to embodiments of the present invention.

FIG. 5 is a flowchart illustrating the method for establishing connection between the enquirer node 10 and the one or more helper nodes 20 for data exchange according to one embodiment of the present invention, and the method of present invention may perform the following steps. In step S101, the communication module 103 of the enquirer node 10 may send an IP address, a context related to the environment and a connection request of the enquirer node 10 to the management server 30. In one embodiment of the present invention, the context related to the environment may be asking directions or requesting suggestion on decision making. In step S102, the management server may send the IP address, the context related to the environment and the connection request of the enquirer node 10 to the communication module 303 of the one or more one or more helper nodes 20. In one embodiment of the present invention, the step S101 and S102 may be combined by eliminating the management server 30 and sending the IP address, the context related to the environment and the connection request of the enquirer node 10 from the enquirer node 10 to the one or more one or more helper nodes 20. In one embodiment of the present invention, the step S101 may further include receiving by the enquirer node 10 user input data indicating an ID from a contact list stored in the memory 102 of the enquirer node 10. For example, the ID may belong to a first helper node 21. The step S102 may the further match the enquirer node 10 to the first helper node 21. In another embodiment of the present invention, the step S101 may further include sending geographic data of the environment surrounding the enquirer node 10 to the management server 30, wherein, further included in the step S102, the geographic data may help to match the enquirer node 10 to the one or more helper nodes 20 near the geographic location the enquirer node 10 is in. In step S103, the connection between the enquirer node 10 and the one or more helper nodes 20 may be established. The connection may comprise a video streaming layer for transmitting video streaming data to the one or more helper nodes 20 and a interaction layer for exchanging user input data between the enquirer node 10 and the one or more helper nodes 20. In one embodiment of the present invention, the connection may further include a voice communication layer for exchanging vocal data, such as a question being asked and command or suggestion provided vocally between the enquirer node 10 and the one or more helper nodes 20. In step 104, the enquirer node 10 may obtain the video streaming data of the environment where the enquirer node 10 is in and may display the video streaming data by the enquirer node 10. In step S105, the enquirer node 10 may send the video streaming data to the one or more helper nodes 20 via the video streaming layer. In another embodiment of the present invention, the step S104 may further include obtaining object data, wherein the object data may be product information of a product recognized by matching image features. Step S105 may further include sending the product information to the one or more helper nodes 20. In step S106, the one or more helper nodes 20 may display the video streaming data received from the enquirer node 10. In step S107, the one or more helper nodes 20 may detect user input data and apply one or more heuristics to the user input data to determine the user interface operation. The step S107 may also include executing by the one or more helper nodes 20 the user interface operation to the video streaming data and displaying the result of the user interface operation upon the video streaming data. In one embodiment of the present invention, the user input data may be touch data, such as a circle drawn on the touch panel of the one or more helper nodes 20, obtained by the touch sensor. The user input data may also be gesture data, such as a movement captured by the touch sensor. In another embodiment of the present invention, the user interface operation may be a manipulation of the video streaming data such as zoom in/out or pausing the video streaming data, and the one or more helper node 20 may display the manipulated video streaming data instead of the video streaming data according to the user interface operation. In another embodiment of the present invention, the user input data may be indicating a click to make an option corresponding to the context related to the environment of the enquirer node 10. In step S108, the one or more helper nodes 20 may transmit the touch or gesture data to the enquirer node 10 by the communication module 303 via the interaction layer. In step S109, the enquirer node 10 may receive the user input from the one or more helper nodes 20 with the communication module 103 via the interaction layer. The enquirer node 10 may then execute the user interface operation to the video streaming data according to the user input and displays the result of the user interface operation upon the video streaming data. In one embodiment of the present invention, the user interface operation may be a manipulation of the video streaming data such as zoom in/out or pausing the video streaming data, and the enquirer node 10 may display the manipulated video streaming data instead of the video streaming data according to the user interface operation. In another embodiment of the present invention, the step 109 may further include obtaining map information stored in the memory 102 of the enquirer node 10 based on the geographic data, the enquirer node 10 then perform a user interface operation corresponding to the map data to display simultaneously with the video streaming data. While the methods previously described may include a number of steps that may appear to occur in a specific order, it should be appreciated that these methods may contain more or fewer steps, that the order these steps may be exchanged, and that different steps may be combined. For example, the step S103 may be omitted or the steps S103 and S104 may be exchanged.

FIG. 6 is a flowchart illustrating the method for establishing connection between the enquirer node 10 and the one or more helper nodes 20 for data exchange through Social Network Service (SNS) according to one embodiment of the present invention, and the method of present invention may perform the following steps. In step S201, the input module 105 of the enquirer node 10 may receive a user input for sending a context related to the environment, and a connection request of the enquirer node 10 to SNS server. In step S202, the enquirer node 10 may send the IP address, the context related to the environment, and the connection request of the enquirer node 10 and a request to the management server 30 for a link. The link is for the one or more helper nodes 20 to visit and react to the context related to the environment of the enquirer node 10. Reacting to the context related to the environment of the enquirer node 10 may include giving directions or providing suggestions. In step S203, the management server 30 may send the link to the enquirer node 10. In step S204, the enquirer node 10 may send the link and the context related to the environment of the enquirer node 10 to the SNS server. In step S205, the SNS server may send a page containing the link and the context related to the environment of the enquirer node 10 to the one or more one or more helper nodes 20. In step S206, a first helper node 21 from the one or more helper nodes 20 may receive a user input for reacting to the context related to the environment of the enquirer node 10. In step S207, the first helper node 21 may send a request for reacting to the context related to the environment of the enquirer node 10 to the management server 30. In step S208, the management server 30 may send the IP address of the enquirer node 10 to the first helper node 21. Once the first helper node 21 receiving the IP address, the first helper node 21 and the enquirer node 10 may perform steps S103 to S109 for establishing connection and exchanging data. While the methods previously described may include a number of steps that may appear to occur in a specific order, it should be appreciated that these methods may contain more or fewer steps, that the order these steps may be exchanged, and that different steps may be combined.

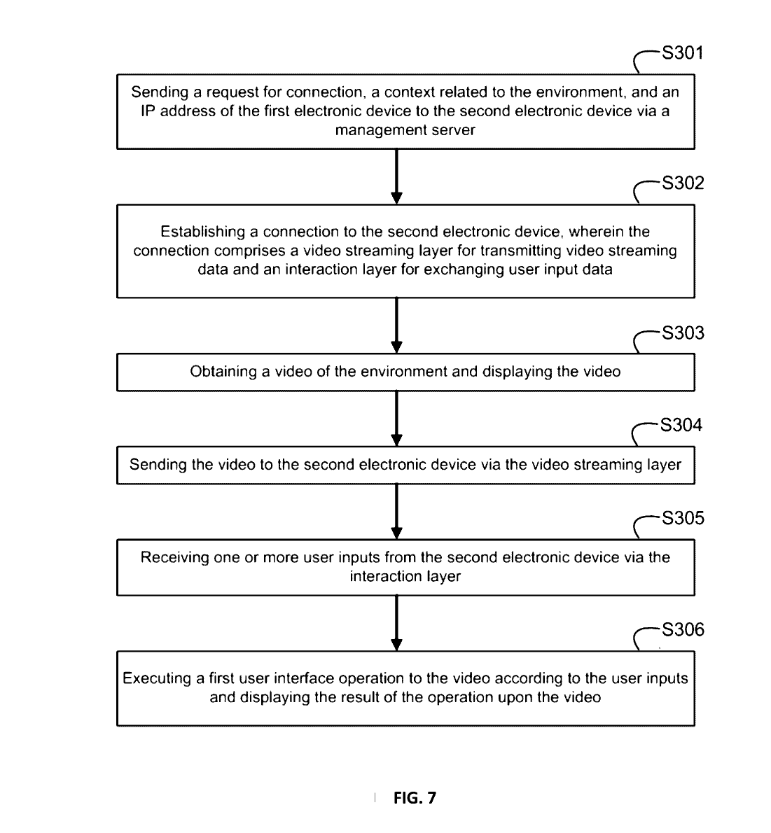

FIG. 7 illustrates the method for matching the first electronic device 100 to the one or more helper nodes 20 according to one embodiment of the present invention, and the method may be implemented as a set of instructions, in one embodiment of the present invention, stored in the memory 102, in the first electronic device 100. The method may perform the following steps. In step S301, the first electronic device 100 may send a request for connection, a context related to the environment, and an IP address of the first electronic device 100 to the one or more helper nodes 20 via a management server 30. In step S302, the first electronic device 100 may establish a connection between the first electronic device 100 and the one or more one or more helper nodes 20, and wherein the connection comprises a video streaming layer for transmitting video streaming data to the one or more helper nodes 20 and an interaction layer for exchanging user input data from the one or more helper nodes 20 and transmitting control data to the one or more helper nodes 20. The connection may be established by User Datagram Protocol (UDP) hole punching. In step S303, the first electronic device 100 may obtain video streaming data of the environment and displaying the video streaming data by the first electronic device 100. In step S304, the first electronic device 100 may send the video streaming data to the one or more helper nodes 20 via the video streaming layer for being displayed by the one or more helper nodes 20. In step S305, the first electronic device 100 may receive one or more user inputs from the one or more helper nodes 20 via the interaction layer. In step S306, the first electronic device 100 may execute the user interface operation to the video streaming data according to the user inputs and displaying the result of the user interface operation upon the video streaming data.

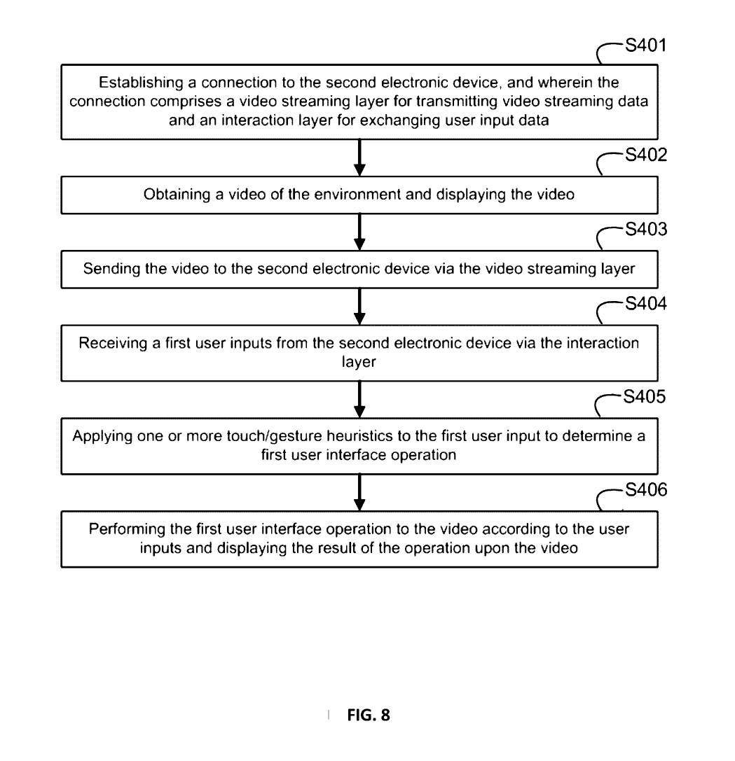

FIG. 8 illustrates the method for matching the first electronic device 100 to the one or more helper nodes 20 according to another embodiment of the present invention, and the method may be implemented as a set of instructions, in one embodiment of the present invention, stored in the memory 102, in the first electronic device 100. The method may perform the following steps. In step S401, the first electronic device 100 may establish a connection between the first electronic device 100 and the second electronic device, and wherein the connection comprises a video streaming layer for transmitting video streaming data to the one or more helper nodes 20 and an interaction layer for exchanging user input data from the one or more helper nodes 20 and transmitting control data to the one or more helper nodes 20. The connection may be established by UDP hole punching. In step S402, the first electronic device 100 may obtain video streaming data of the environment and displaying the video streaming data by the first electronic device 100. In step S403, the first electronic device 100 may send the video streaming data to the one or more helper nodes 20 via the video streaming layer for being displayed by the one or more helper nodes 20. In step S404, the first electronic device 100 may receive a first user input from the one or more helper nodes 20 via the interaction layer. The first user input may be touch data obtained by a touch sensor sensing a location being touch by finger on the touch panel of the one or more helper nodes 20. The first user input may also be gesture data detected by a light sensor. In step S405, if the first user input is the touch data, the first electronic device 100 may apply one or more touch heuristics to the first user input to determine a first user interface operation. If the first user input is the gesture data, the first electronic device 100 may apply one or more gesture heuristics to the first user input to determine a first user interface operation. In step S406, the first electronic device 100 may perform the first user interface operation to the video streaming data according to the user inputs and display the result of the operation upon the video streaming data. The one or more heuristics may include recognizing the shape being drawn on the touch panel of the one or more helper nodes 20 and recognizing the movement with the light source being captured by the light sensor.

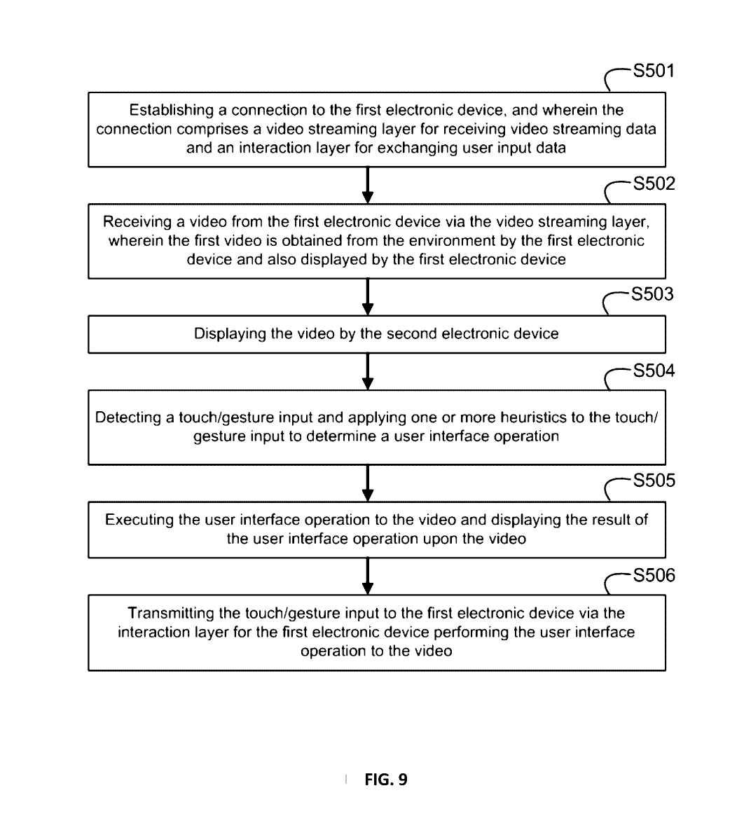

FIG. 9 illustrates the method for matching the second electronic device 300 to the enquirer nodes 10 according to one embodiment of the present invention, and the method may be implemented as a set of instructions, in one embodiment of the present invention, stored in the memory 302, in the second electronic device 300. The method may perform the following steps. In step S501, the second electronic device 300 may establish a connection between the second electronic device 300 and enquirer node 10, and wherein the connection comprises a video streaming layer for receiving video streaming data from the enquirer node 10 and an interaction layer for exchanging user input data between the second electronic devices 300 and the enquirer node 10. In step S502, the second electronic device 300 may receive first video streaming data from the enquirer node 10 via the video streaming layer, wherein the first video streaming data is obtained from the environment by the enquirer node 10 and also displayed by the enquirer node 10. In step S503, the second electronic device 300 may display the first video streaming data. In step S504, the second electronic device 300 may detect user input data and applying one or more heuristics to the input data to determine a user interface operation. The user input data detected may be touch data obtained by a touch sensor sensing a location being touch by finger on the touch panel of the enquirer node 10. The first user input may also be gesture data detected by a light sensor. The one or more heuristics may include recognizing the shape being drawn on the touch panel of the second electronic device 300 and recognizing the movement with the light source being captured by the light sensor. In step S505, the second electronic device 300 may execute the user interface operation to the first video streaming data and displaying the result of the user interface operation upon the first video streaming data. In step S506, the second electronic device 300 may transmit the user input data to the enquirer node 10 via the interaction layer for the enquirer node 10 performing the user interface operation to the first video streaming data.

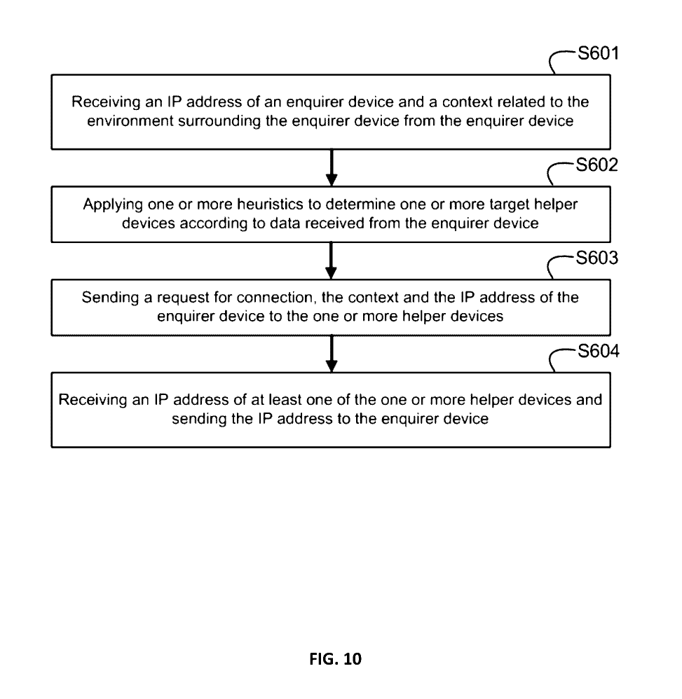

FIG. 10 illustrates the method for matching the enquirer nodes 10 to the one or more helper nodes 20 via the management server 30 according to one embodiment of the present invention, and the method may be implemented as a set of instructions, in one embodiment of the present invention, stored in the memory of the management server 30. The method may perform the following steps. In step S601, management server 30 may receive the IP address of the enquirer node 10 and a context related to the environment surrounding the enquirer node 10 from the enquirer device. In step S602, management server 30 may match at least one of the one or more helper nodes 20 such as a first helper node 21 and send the IP address, the context and the connection request to the first helper node 21. In step S603, management server 30 may send a request for connection, the context and the IP address of the enquirer node 10 to the one or more helper nodes 20. In step S604, management server 30 may receive the IP address of at least one of the one or more helper nodes 20 and sending the IP address to the enquirer node 10. As a result, the enquire node 10 and at least one of the one or more helper nodes 20 may have the IP address of each other. The enquire node 10 and at least one of the one or more helper nodes 20 may establish a connection between each other based on the IP addresses.

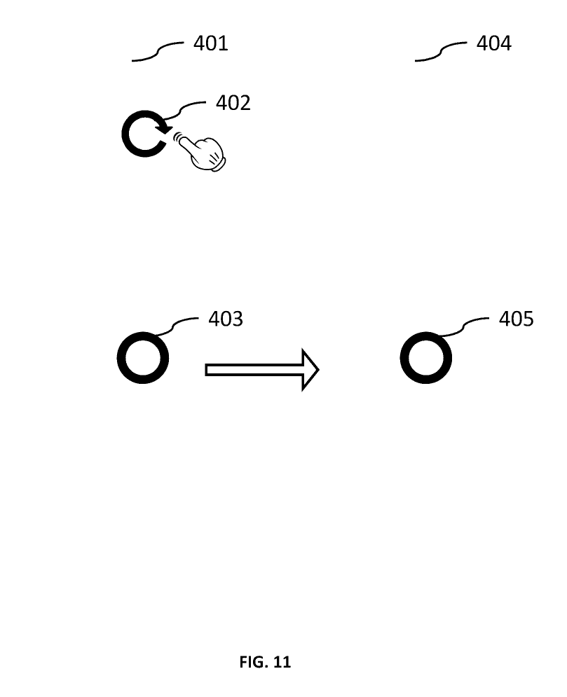

FIG. 11 schematically illustrates a series of user interface operations performed for real-time interaction between the enquirer node 10 and the one or more helper nodes 20 according to one embodiment of the present invention. Video streaming data 401 may be displayed on the one or more helper nodes 20 after received by the communication module 303 of the one or more helper nodes 20 through interaction layer from the enquirer node 10. The one or more helper nodes 20 and the one or more enquirer nodes 10 may share the same video streaming data 401 on their display. The one or more helper nodes 20 may further receive user input data and transmit to user interface data 402. For example, the user input may be a circle drawn by finger on the touch panel of the one or more helper nodes 20. The one or more helper nodes 20 may execute a first user interface operation to obtain a first result 403 according to the user interface data 402 and display the first result 403 over the video streaming data 401. The one or more helper nodes 20 may then send the user interface data 402 to the enquirer node 10 via the interaction layer. The enquirer node 10 may execute a second user interface operation according to the user interface data 402 received and obtain a second result 405. The enquirer node 10 may display the second result 405 over video streaming data 404. The video streaming data 404 may be the same with video streaming data 401 displayed on the one or more helper nodes 20.

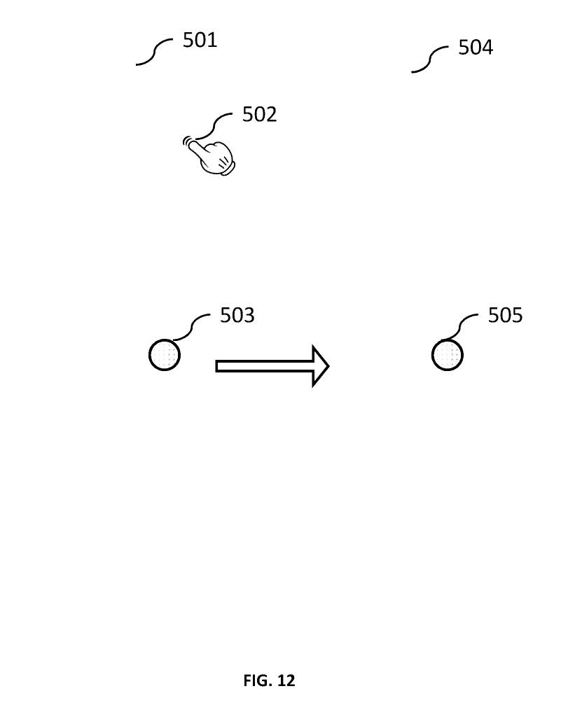

FIG. 12 schematically illustrates a series of user interface operations performed for real-time interaction between the enquirer node 10 and the one or more helper nodes 20 according to another embodiment of the present invention. Video streaming data 501 may be displayed on the one or more helper nodes 20 after received by the communication module 303 of the one or more helper nodes 20 through interaction layer from the enquirer node 10. The one or more helper nodes 20 may receive user input data and transmit to user interface data 502, wherein the user input data may be a tap on the touch panel of the one or more helper nodes 20. The one or more helper nodes 20 may execute a first user interface operation to obtain a first result 503 according to the user interface data 502 and display the first result 503 over the video streaming data 501. The first result 503 may be a circle displayed over the video streaming data 501. The one or more helper nodes 20 may then send the user interface data 502 to the enquirer node 10 via the interaction layer. The enquirer node 10 may execute a second user interface operation according to the user interface data 502 received and obtain a second result 505, wherein the second result 505 may be a similar circle corresponding to the first result 503. The enquirer node 10 may display the second result 505 over video streaming data 504. The video streaming data 504 may be the same with video streaming data 501 displayed on the one or more helper nodes 20.

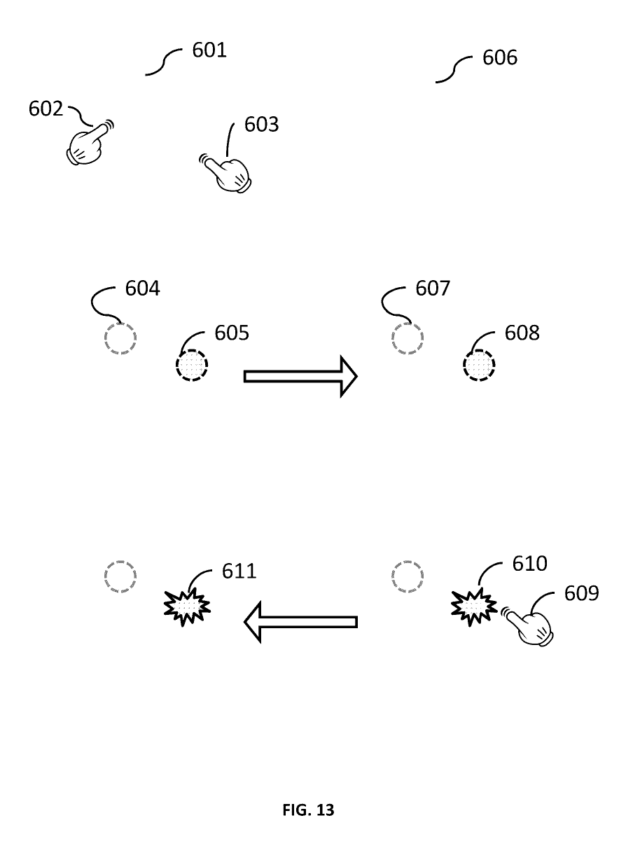

FIG. 13 schematically illustrates a series of user interface operations performed for collaboration between the enquirer node 10 and one or more helper nodes 20 according to one embodiment of the present invention. First video streaming data 601 may be displayed on the enquirer node 10. The video streaming data, for example, may be a screen shot, the enquirer node 10 may receive first user input data and second user input data and transmit to first user interface data 602 and second user interface data 603, wherein the first and second user input data may be taps locating on items on the screen displaying the first video streaming data 601. The enquirer node 10 may execute a first user interface operation to obtain a first result 604 and a second result 605 according to the first user interface data 602 and the second user interface data 603 and display the first result 604 and the second result 605 over the first video streaming data 601. The first result 604 and the second result 605 may be circles locating over the items shown on the video streaming data. The enquirer node 10 may then send the first user interface data 602 and the second user interface data 603 to the one or more helper nodes 20 via the interaction layer. The one or more helper nodes 20 may execute a second user interface operation according to the first user interface data 602 and the second user interface data 603 received and obtain a third result 607 and a fourth result 608, wherein the third result 607 and the fourth result 608 may be similar circles corresponding to the first result 604 and the second result 605. The one or more helper nodes 20 may display the third result 607 and the fourth result 608 over second video streaming data 606. The one or more helper nodes 20 may receive third user input data and transmit to the third user input data to third user interface data 609. The third user input data, for example, may be a tap on the touch panel of the one or more helper nodes 20 indicating an option made corresponding to the third result 607 and the fourth result 608. The one or more helper nodes 20 may execute a third user interface operation according to the third user interface data 609 to obtain a fifth result 610, wherein the fifth 610 result may be a splash icon to replace the fourth result 608 and to differentiate from the third result 607. The fifth result 610 may be displayed over the second video streaming data 606 replacing the fourth result 608. The one or more helper nodes 20 may then send the third user interface data 609 to the enquirer node 10 via the interaction layer. The enquirer node 10 may execute a fourth user interface operation to obtain a sixth result 611 according to the third user interface data 609 and display the sixth result 611 over the first video streaming data 601 replacing the second result 605. The second video streaming data 606 may be the same with first video streaming data 601 displayed on the enquirer node 10.

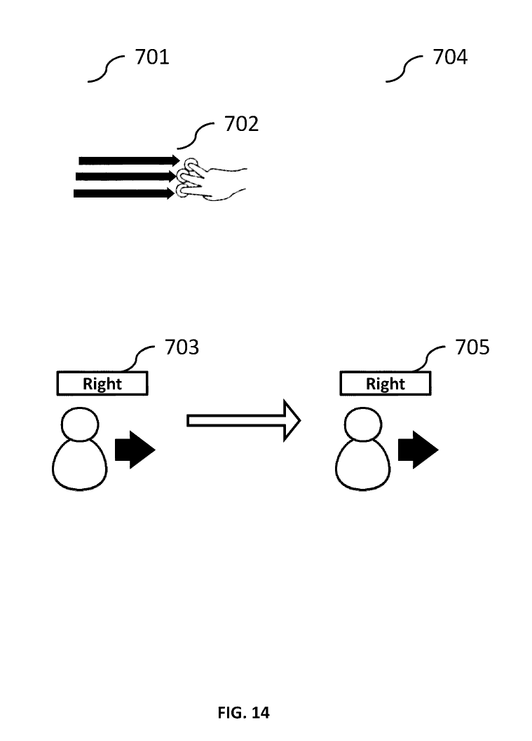

FIG. 14 schematically illustrates a series of user interface operations performed for real-time interaction between the enquirer node 10 and the one or more helper nodes 20 according to one embodiment of the present invention. Video streaming data 701 may be displayed on the one or more helper nodes 20 after received by the communication module 303 of the one or more helper nodes 20 through interaction layer from the enquirer node 10. The one or more helper nodes 20 may receive user input data and transmit to user interface data 702, wherein the user input data may be a swipe with fingers from left to right across the touch panel of the one or more helper nodes 20. The one or more helper nodes 20 may execute a first user interface operation to obtain a first result 703 according to the user interface data 702 and display the first result 703 over the video streaming data 701. The first result 703 may be a command corresponding to the user input data, an indication for right turn for example, displayed over the video streaming data 701. The one or more helper nodes 20 may then send the user interface data 702 to the enquirer node 10 via the interaction layer. The enquirer node 10 may execute a second user interface operation according to the user interface data 702 received and obtain a second result 705, wherein the second result 705 may be a similar command corresponding to the first result 703, a command to turn right for example. The enquirer node 10 may display the second result 705 over video streaming data 704. The video streaming data 704 may be the same with video streaming data 701 displayed on the one or more helper nodes 20.

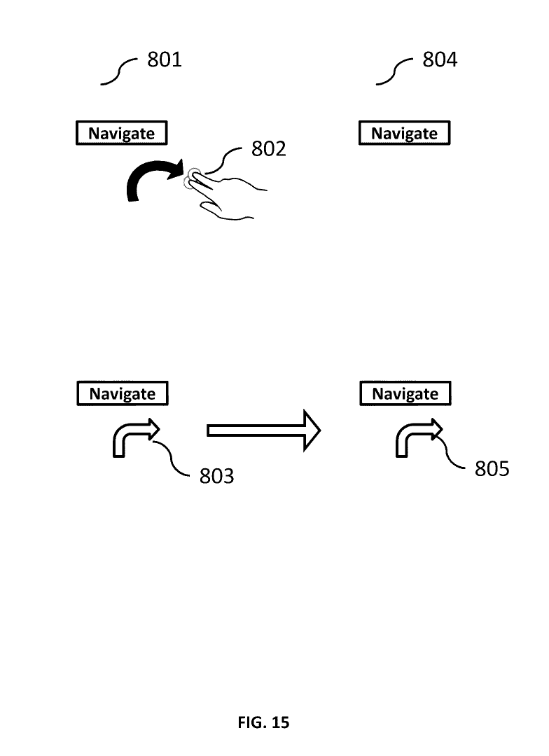

FIG. 15 schematically illustrates a series of user interface operations performed for navigation instruction from the one or more helper nodes 20 to the computing device 200 according to one embodiment of the present invention. Video streaming data 801 may be displayed on the one or more helper nodes 20 after received by the communication module 303 of the one or more helper nodes 20 through interaction layer from the computing device 200. The one or more helper nodes 20 may receive user input data and transmit to user interface data 802, wherein the user input data may be a semicircle drawn with two fingers from left to right across the touch panel of the one or more helper nodes 20. The one or more helper nodes 20 may execute a first user interface operation to obtain a first result 803 according to the user interface data 802 and display the first result 803 over the video streaming data 801. The first result 803 may be a command corresponding to the user input data, an indication for right turn for example, displayed over the video streaming data 801. The one or more helper nodes 20 may then send the user interface data 802 to the computing device 200 via the interaction layer. The computing device 200 may execute a second user interface operation according to the user interface data 802 received and obtain a second result 805, wherein the second result 805 may be a navigating command corresponding to the first result 803 to the vehicle body, a command to turn right for example.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

1. A method for enabling real-time interaction between a first electronic device and a second electronic device, the method being implemented in the first electronic device, and the method comprising:
sending by the first electronic device a request for connection, a context related to the environment, and an IP address of the first electronic device to the second electronic device via a management server, and wherein the management server matches the first electronic device to the second electronic device according to data received from the first electronic device;
establishing by the first electronic device a connection between the first electronic device and the second electronic device, and wherein the connection comprises a video streaming layer for transmitting video streaming data to the second electronic device and an interaction layer for exchanging user input data from the second electronic device and transmitting control data to the second electronic device;
obtaining by the first electronic device a video the environment and displaying the video by the first electronic device;
sending by the first electronic device the video to the second electronic device via the video streaming layer for being displayed by the second electronic device;
receiving by the first electronic device one or more user inputs from the second electronic device via the interaction layer; and
executing by the first electronic device a first user interface operation to the video according to the user inputs and displaying the result of the operation upon the video.

2. The method according to claim 1, further comprising:
receiving an identification of the second device by the first electronic device; and
sending the identification to the second electronic device via the management server, and wherein the management server matches the first electronic device to the second electronic device according to the identification.

3. The method according to claim 1, further comprising:
receiving a link generated according to the request, the context and the IP address from the management server, and wherein the link enables one or more visitors to receive the request, the context and the IP address from the management server; and
generating an Social Network Service message including the link and sending to a Social Network Service server.

4. The method according to claim 1, further comprising:
obtaining by the first electronic device geographic data collected from the environment; and
sending by the first electronic device the geographic data to the second electronic device via the interaction layer for being displayed simultaneously with the video on the second electronic device.

5. The method according to claim 1, further comprising:
recognizing by the first electronic device an object from the video;
obtaining one or more characteristics of the object by the first electronic device; and
sending by the first electronic device the one or more characteristics to the second electronic device via the interaction layer for being displayed simultaneously with the video by the second electronic device.

6. The method according to claim 1, further comprising:
applying by the first electronic device one or more heuristics to the user inputs and the video to determine one or more commands defining interactions with the environment; and
executing by the first electronic device the one or more commends to control the first electronic device to perform the interactions with the environment.

7. The method according to claim 4, further comprising:
obtaining map data based on the geographic data by the first electronic device; and
performing by the first electronic device a second user interface operation to display the map data simultaneously with the video.

8. A method for enabling real-time interaction between a first electronic device and a second electronic device, the method being implemented in the first electronic device, and the method comprising:
establishing by the first electronic device a connection between the first electronic device and the second electronic device, and wherein the connection comprises a video streaming layer for transmitting video streaming data to the second electronic device and an interaction layer for exchanging user input data selected from touch data or gesture data between the first and the second electronic devices;
obtaining by the first electronic device a video from the environment and displaying the video by the first electronic device;
sending by the first electronic device the video to the second electronic device via the video streaming layer for being displayed by the second electronic device;
receiving by the first electronic device a first user input from the second electronic device via the interaction layer;
applying one or more touch/gesture heuristics to the first user input to determine a first user interface operation;
performing the first user interface operation to the video and
displaying the result of the first user interface operation upon the video.

9. The method according to claim 8, wherein the first user interface operation defines manipulation of the video and wherein the first electronic device displays manipulated video instead of the video according to the first user interface operation.

10. The method according to claim 8, further comprising:
obtaining by the first electronic device a screen shot including a frame image of the video and the result of the first user interface operation; and
sending the screen shot to the second electronic device via the interaction layer.

11. The method according to claim 8, wherein the connection further comprises a voice communication layer for exchanging voice data between the first electronic device and the second electronic device.

12. The method according to claim 8, further comprising:
receiving touch/gesture data by the first electronic device from a user while displaying the video;
performing a third user interface operation to the video according to the touch/gesture data and displaying the result of the third user interface operation upon the video; and
sending the touch/gesture data to the second electronic device via the interaction layer for the second electronic device performing the third user interface operation according to the touch/gesture data.

13. A first electronic device for enabling real-time connection and interaction with another electronic device, comprising:
one or more processors;
a memory;
a communication module controlled by the one or more processors;
a video capture unit connected to the memory and controlled by the one or more processors;
an input module;
a display; and
one or more programs, wherein the one or more programs are stored in the memory and configured to be executed by the one or more processors, the one or more programs including:
instructions for sending a request for connection, a context related to the environment received by the input module, and an IP address of the first electronic device to a second electronic device via a management server, and wherein the management server matches the first electronic device to the second electronic device according to data received from the first electronic device;
instructions for establishing a connection between the first electronic device and the second electronic device by the communication module, and the connection comprises a video streaming layer for transmitting video streaming data to the second electronic device and an interaction layer for exchanging user input data between the first and the second electronic devices;
instructions for obtaining a video from the environment by the video capture unit and displaying the video on the display;
instructions for sending by the communication module the video to the second electronic device via the video streaming layer for being displayed by the second electronic device;
instructions for receiving by the communication module one or more user inputs from the second electronic device via the interaction layer;
instructions for executing a user interface operation to the video according to the one or more user inputs and displaying the result of the user interface operation upon the video on the display.

14. The first electronic device according to claim 13, further comprising:
a geographic sensor, wherein the geographic sensor obtains geographic data from the environment; and
wherein the one or more programs further comprises instructions for sending the geographic data to the second electronic device via the interaction layer by the communication module.

15. The first electronic device according to claim 14, wherein the first electronic device is incorporated in a vehicle.

16. The first electronic device according to claim 14, wherein the one or more programs further comprises:
instructions for obtaining map data based on the geographic data by the geographic sensor;
instructions for performing a second user interface operation to display the map data simultaneously with the video; and
instructions for displaying by the first electronic device the second result.

17. The first electronic device according to claim 14, wherein the one or more programs further comprises:
instructions for recognizing an object from the video;
instructions for obtaining one or more characteristics of the object; and
instructions for sending the one or more characteristics to the second electronic device via the interaction layer by the communication module for being displayed upon the video by the second electronic device.

18. The first electronic device according to claim 13, further comprising a recorder module for storing the video.

19. A first electronic device for enabling real-time connection and interaction with another electronic device, comprising:
one or more processors;
a memory;
a communication module controlled by the one or more processors;
a video capture unit connected to the memory and controlled by the one or more processors;
an input module;
a display; and
one or more programs, wherein the one or more programs are stored in the memory and configured to be executed by the one or more processors, the one or more programs including:
instructions for establishing a connection between the first electronic device and the second electronic device by the communication module, and wherein the connection comprises a video streaming layer for transmitting video streaming data to the second electronic device and an interaction layer for exchanging user input data between the first and the second electronic devices;
instructions for obtaining by the first electronic device a video from the environment and displaying the video on the display;
instructions for sending the video to the second electronic device by the communication module via the video streaming layer for being displayed by the second electronic device;
instructions for receiving a first user inputs by the communication module from the second electronic device via the interaction layer;
instructions for applying one or more touch/gesture heuristics to the first user input to determine an user interface operation;
instructions for performing the user interface operation to the video and displaying the result of the user interface operation upon the video on the display.

20. The first electronic device according to claim 19, wherein the input module comprises one or more touch sensors for detecting finger contacts and generating touch data, and wherein the one or more programs further include:
instructions for applying one or more touch heuristics to the touch data to determine a second user input;
instructions for performing a second user interface operation to the video according to the second user input and displaying the result of the second user interface operation upon the video; and
instructions for sending the second user input to the second electronic device by the communication module via the interaction layer for the second electronic device performing the second user interface operation according to the second user input.

21. The first electronic device according to claim 19, wherein the input module comprises one or more light sensors for detecting user behavior and generating gesture data, and wherein the one or more programs further include:
instructions for applying one or more gesture heuristics to the gesture data to determine a third user input;
instructions for performing a third user interface operation to the video according to the third user input and displaying the result of the third user interface operation upon the video; and
instructions for sending the third user input to the second electronic device by the communication module via the interaction layer for the second electronic device performing the third user interface operation according to the third user input.

22. The first electronic device according to claim 18, wherein the one or more programs further include:
instructions for obtaining a screen shot including a frame image of the video and the result of the first user interface operation; and
instructions for sending the screen shot to the second electronic device via the interaction layer by the communication module.

23. A vehicle for enabling real-time interaction with another electronic devices, comprising:
a vehicle body;
a computing device controlling the vehicle body and incorporated in the vehicle body, and wherein the computing device comprises:
one or more processors;
a memory;
a communication module controlled by the one or more processors;
a video capture unit connected to the memory and controlled by the one or more processors; and
one or more programs, wherein the one or more programs are stored in the memory and configured to be executed by the one or more processors, the one or more programs including:
instructions for establishing a connection between the vehicle and the second electronic device by the communication module, and wherein the connection comprises a video streaming layer for transmitting video streaming data to the second electronic device and an interaction layer for exchanging user input data between the vehicle and the second electronic devices;
instructions for obtaining a video from the environment by the video capture unit;
instructions for sending the video to the second electronic device by the communication module via the video streaming layer for being displayed by the second electronic device;
instructions for receiving one or more user inputs by the communication module from the second electronic device via the interaction layer;
instructions for applying one or more heuristics to one or more user inputs determine one or more commands defining interactions between the vehicle and the environment; and
instructions for executing the one or more commands to control the vehicle body to perform the interactions with the environment.

24. The vehicle according to claim 23, wherein the one or more user inputs further comprise a set of touch data defining at least a location corresponding to the environment in one or more frame images of the video, and wherein the one or more commands include instructions for controlling the vehicle body to move to the location in the environment.

25. The vehicle according to claim 23, wherein the one or more programs further comprise instructions for sending a request for connection, a pre-set context, and an IP address of the vehicle to the second electronic device via a management server, and wherein the management server matches the vehicle to the second electronic device according to data received from the vehicle.

26. A method for enabling real-time interaction between a first and second electronic devices, the method being implemented in the second electronic device, and the method comprising:
establishing by the second electronic device a connection between the first electronic device and the second electronic device, and wherein the connection comprises a video streaming layer for transmitting video streaming data from the first electronic device and an interaction layer for exchanging user input data between the first and the second electronic devices;
receiving by the second electronic device a video from the first electronic device via the video streaming layer, wherein the first video is obtained from the environment by the first electronic device and also displayed by the first electronic device;
displaying the video by the second electronic device;
detecting a touch/gesture input by the second electronic device and applying one or more heuristics to the touch/gesture input to determine a user interface operation;
executing by the second electronic device the user interface operation to the video and displaying the result of the user interface operation upon the video; and
transmitting by the second electronic device the touch/gesture input to the first electronic device via the interaction layer for the first electronic device performing the user interface operation to the video.

27. The method according to claim 26, wherein the touch/gesture input corresponds to a position of finger contact upon a touch screen of the second electronic device, and wherein the user interface operation corresponds to rendering a user interface at the position.

28. The method according to claim 26, wherein the touch/gesture input corresponds to a moving path of finger contacts upon a touch screen of the second electronic device, and wherein the user interface operation corresponds to rendering a user interface along the moving path.

29. The method according to claim 26, wherein the touch/gesture input corresponds to one or more finger contacts upon a touch screen of the second electronic device, and wherein the second electronic device further identifies a gesture from the touch/gesture input and determines a corresponding video manipulation as the user interface operation.

30. The method according to claim 26, wherein the connection further comprises a voice communication layer for exchanging voice data between the first electronic device and the second electronic device.

31. A second electronic device for enabling real-time connection and interaction with another electronic device, comprising:
one or more processors;
a memory;
a communication module controlled by the one or more processors;
an input module;
a display; and
one or more programs, wherein the one or more programs are stored in the memory and configured to be executed by the one or more processors, the one or more programs including:
instructions for receiving by the communication module an IP address of a first electronic device, a context related to environment surrounding the first electronic device and a connection request from a management server;
instructions for establishing by the communication module a connection between the first electronic device and the second electronic device, and wherein the connection comprises a video streaming layer for receiving video streaming data from the first electronic device and an interaction layer for exchanging user input data between the first and the second electronic devices;
instructions for receiving by the communication module a video from the first electronic device via the video streaming layer, wherein the video is obtained from the environment surrounding the first electronic device by the first electronic device and also displayed by the first electronic device;
instructions for displaying the video on the display;
instructions for detecting a touch/gesture input by the input module and applying one or more heuristics to the touch/gesture input to determine a user interface operation;
instructions for executing the user interface operation to the video and displaying the result of the user interface operation upon the video on the display; and
instructions for transmitting by the communication module the touch/gesture input to the first electronic device via the interaction layer for the first electronic device performing the user interface operation to the video.

32. The second electronic device according to claim 28, wherein the input module comprises one or more touch sensors to detect finger contacts and generate the touch/gesture input.

33. The second electronic device according to claim 28, wherein the input module comprises one or more light sensors identifying at least a gesture and generate the touch/gesture input.

34. A method for enabling real-time interaction comprising:
receiving by a management server an IP address of an enquirer device and a context related to the environment surrounding the enquirer device from the enquirer device;
applying one or more heuristics by the management server to determine one or more target helper devices according to data received from the enquirer device;
sending by the management server a request for connection, the context and the IP address of the enquirer device to the one or more helper devices;
receiving an IP address of at least one of the one or more helper devices and sending the IP address to the enquirer device;
wherein the helper device establish a connection with the enquirer device, and wherein the connection comprises a video streaming layer for a video collected from the environment from the enquirer device to the helper device and an interaction layer for exchanging user input data between the enquirer device and the helper device; and
wherein both the enquirer device and the helper device displays the video and one or more user interfaces generated according to the user input data upon the video.

35. The method according to claim 34, wherein the one or more heuristics further comprise a heuristic for determining devices communicably connected to the management server as the one or more helper devices.

36. The method according to claim 34, further comprising:
receiving by the management server a geographic position of the enquirer device; and
wherein the one or more heuristics comprises a heuristic for determining one or more helper devices based on the geographic position of the enquirer device.

37. The method according to claim 34, further comprising:
generating a link based on the according to data received from the enquirer device and sending the link to the enquirer device; and
wherein the one or more heuristics comprises a heuristic for determining the one or more visitors of the link corresponds to the one or more helper devices.

38. A network for enabling real-time interaction comprising:
an enquirer node having a video capture unit to collect a video from the environment, a first UI module for receiving first user input and generating a first user interface corresponding to the first user input and a display for displaying the video and the first user interface upon the video;
a helper node communicably connected to the enquirer node and having a second UI module for receiving second user input and generating a second user interface corresponding to the second user input and a display for displaying the video and the second user interface upon the video;
wherein the enquirer node and the helper node establish a connection between each other, and wherein the connection comprises a video streaming layer for transmitting the video in form of video streaming data from the enquirer node to the helper node and an interaction layer for exchanging the first and the second user input between the enquirer node and the helper node;
wherein the enquirer node generates the second user interface with the first UI module according to the second user input received from the helper node via the interaction layer and displays the second user interface upon the video; and
wherein the helper node generates the first user interface with the second UI module according to the first user input received from the enquirer node via the interaction layer and displays the first user interface upon the video.

39. The network according to claim 36, further comprising:
a management server communicably connected to the enquire node and the helper node; and
wherein the enquire node transmits its IP address, a context related to the environment and a connection request to the management server;
wherein the management server matches the enquire node to the helper node according to data received from the enquire node; and
wherein the management server sends the IP address, the context and the connection request to the helper node and the IP address of the helper node to the enquire node for the enquire node and the helper node to establish the connection between each other,

40. The connection network according to claim 36, wherein the connection further comprises a voice communication layer for exchanging voice data between the enquire node and the helper node.
